(19) United States
(12) Patent Application Publication
(10) Pub. No.: US 2010/0225111 A1
(43) Pub. Date: Sep. 9, 2010

(54) GASKET FOR BELL SOCKET

(76) Inventor: William H. OWEN, Fultondale, AL (US)

Correspondence Address: REMENICK PLLC, 1025 THOMAS JEFFERSON STREET, NW, WASHINGTON, DC, 20007, US

(21) Appl. No.: 12/716,820

(22) Filed: Mar. 3, 2010

Related U.S. Application Data
(60) Provisional application No. 61/156,998, filed on Mar. 3, 2009.
(60) Provisional application No. 61/167,716, filed on Apr. 8, 2009.

(51) Int. Cl. F16J 15/06; F16J 15/10; F16J 15/12; F16L 21/02; F16L 21/03

(52) U.S. Cl. 285/374; 277/616; 277/615

(57) ABSTRACT

A gasket and a piping system using the gasket are disclosed. The gasket has an o-shaped body including an inner diameter and an outer diameter. The gasket further may include at least one gasket retaining bar attached to the body that bar prevents the gasket from being displaced while the spigot is being inserted into the gasket. The gasket may also include at least one restraining device attached to the body. The restraining device has at least one edge that extends beyond the inner diameter of the body of the gasket to engage the spigot.

### REFERENCE TO RELATED APPLICATIONS

This application claims priority to U.S. provisional application No. 61/156,998, filed Mar. 3, 2009, entitled “Gasket for Bell Socket,” and U.S. provisional application No. 61/167,716, filed Apr. 8, 2009, entitled “Gasket for Bell Socket,” both of which are specifically and entirely incorporated herein by reference.

### BACKGROUND

1. Field of the Invention

The invention is directed to gaskets and, in particularly, to gaskets for bell and spigot pipe connections.

2. Background of the Invention

Due to thrust forces, earth movement, and external mechanical forces exerted on pipes, the industry has focused substantial attention on the problem of maintaining connections between adjacent lengths of pipe, or pipes and fittings, after installation. The majority of the solutions can be categorized into either “push-on joints,” “mechanical joints,” or “flanged joints.”

Push-on solutions are exemplified by U.S. Pat. No. 2,953,398, and account for the majority of straight-run pipe connections. In a typical configuration, a spigot end of a pipe slides into a bell end of another pipe past a tightly fitted gasket. A variation of the push-on joint is evidenced by U.S. Pat. No. 2,201,372, which employs a compression snap-ring fitted within a special lip of the bell, in order to exert pressure onto locking segments and thus drive them into the spigot, restraining the joint against thrust forces. U.S. Pat. No. 3,445,120, likewise employs a gasket with stiffening segments completely encased therein that are generally disposed such that they and the gasket may roll between a locking and a free position. As the gasket rolls under extraction forces, it is intended eventually to encounter a position in which the stiffened plane needs to compress for further rolling, in theory terminating the rolling and restraining the joint.

Other examples of restrained push-on joints include U.S. Pat. Nos. 5,295,697, 5,464,228, and 5,067,75,1. The securement of the connection in such references is effected by locking segments or wedges within the gasket that engage the spigot. The locking segments possess a grove that mates with an annular rib on the bell, such that the rib acts as a rocker, or cam, or during some movements, as a wedge. During insertion of the spigot into the bell, the segments rotate on the rib, but are prevented from appreciable straight-line movement by the mating of the rib and groove. Upon experiencing counter-forces tending to effect removal of the spigot, the rib acts as a cam, both causing the segments to pivot on the rib as an axis, and exerting a radially inward pressure as the segment attempts to slide past the rib.

It often takes a high degree of skill and precision to assemble pipes using the above described gaskets. Furthermore, the current trend is to make pipe with walls much thinner than the current design. Whether the pipe end is produced in a manufacturing plant or is the result of field cuts required to adjust the length of the pipe, such pipes cannot be beveled or have rounded ends. Damage to the gaskets or displacement of the gaskets is a likely outcome when inserting a spigot end of a pipe without a beveled or rounded end into the bell end of another push-on joint pipe. Therefore, it is desirable to have a gasket that is durable yet easy to assemble.

### SUMMARY OF THE INVENTION

The present invention overcomes the problems and disadvantages associated with current strategies and designs and provides new devices for assembling pipes.

One embodiment of the present invention is directed to a gasket. The gasket includes an o-shaped body having an inner diameter and an outer diameter. The gasket further may include gasket retaining bars attached to or molded into the outside surface of the of the cylindrical body, which prevent the gasket from being displaced from the bell socket of one pipe upon insertion of the spigot of another pipe to complete the joining of the two pipes.

The retaining bars may be molded into the outer diameter of the body of the gasket and may be evenly spaced around the circumference of the gasket. The retaining bars may be made of steel, hardened steel, or other stiffening material while the body may be made of a flexible material, such as rubber. The gasket is preferably adapted to fit into the inner diameter of a bell end of a pipe.

Another embodiment of the present invention is directed to a gasket also having an o-shaped body with an inner diameter and an outer diameter. The gasket may further include inserts attached to the body, where each has at least one edge which extends beyond the inner diameter of the body. The function of these inserts are to secure the assembled joint from separation.

Preferably there are three or more inserts molded into the body. Each insert may have one or more edges that extend beyond the inner diameter of the body and one edge that extends to the outer diameter of the body. The inserts may be made of steel, hardened steel, or other material harder than the material of the pipe spigot which it is intended to restrain.

The gasket may also include at least one anti-over-rotation device per insert to prevent over-rotation of the inserts when axial forces on the joint are in the direction to pull the pipe spigot from a bell socket containing the gasket. The anti-over-rotation devices may be metal blocks placed adjacent to the inserts.

The body may be made of a flexible material, such as rubber and the gasket may be adapted to fit into the inner diameter of a bell end of a pipe.

Alternatively, there may be inserts having multiple teeth with the inserts equally spaced circumferentially about the gasket. Alternately, each insert may itself be comprised of a number of individual plates placed adjacently and in direct contact to each other and each plate may have at least one tooth. Each insert may be coupled to an outer surface of the gasket and include an end, adjacent to the outer diameter of the gasket, which is at least partially rounded. Each insert may be made of steel, hardened steel, or at least, a material harder than the pipe spigot it is intended to engage.

The gasket may also include gasket retaining bars attached to the body to prevent the gasket from being displaced when the joint is assembled. The gasket retaining bars may be molded into the outer diameter of the body and evenly spaced around the circumference of the gasket. The gasket retaining bars and the inserts may be placed alternatively around the gasket. The gasket retaining bars may be made of steel or hardened steel. The inserts may be restraining devices or guiding devices.

Another embodiment of the present invention is directed to a piping system. The system includes at least two pipes, each pipe having a bell end and a spigot end. The spigot end of a first pipe fits into the bell end of a second pipe. The system also includes at least one gasket adapted to fit into the bell end of a pipe and provide a seal between the spigot end of the first pipe and the bell end of the second pipe. The gasket may have an o-shaped body including an inner diameter and an outer diameter and gasket retaining bars attached to the body that prevents the gasket from being displaced during insertion of the spigot end of a pipe into the bell end of another pipe.

The retaining bars may be molded into the outer diameter of the body and may be evenly spaced around the circumference of the gasket. The retaining bars may be made of steel, hardened steel, or other material harder than the body of the gasket while the body may be made of a flexible material, such as rubber. The gasket is preferably adapted to fit into the inner diameter of a bell end of a pipe.

Another embodiment is also directed to a piping system. The system includes at least two pipes, each pipe having a bell end and a spigot end, wherein the spigot end of a first pipe fits into the bell end of a second pipe. The system further includes at least one gasket that is adapted to fit into the bell end of a pipe and provide a seal between the spigot end of the first pipe and the bell end of the second pipe. Each gasket has an o-shaped body including an inner diameter and an outer diameter and may include three or more inserts coupled to the body. The inserts may have at least one edge that extends beyond the inner diameter of the body and is adapted to engage an outer surface of the spigot end of the first pipe.

There may be a plurality of inserts molded into the body with each insert having one edge that extends to or beyond the inner diameter of the body to engage an outer surface of the spigot end and one edge that extends beyond the outer diameter of the body to engage an inner surface of the bell end. The inserts may be made of steel, hardened steel, or other material harder than the spigot of the pipe. The system may further include anti-over-rotation devices to prevent over-rotation of the inserts during use of the gasket. The anti-over-rotation devices may be metal blocks placed adjacent to the inserts. While the body is made of a flexible material, such as rubber.

Alternatively, there may be multiple inserts having a number of teeth. Each insert can also be comprised of a number of individual plates placed adjacently and in direct contact to each other, each plate having at least one tooth. The restraining devices may be coupled to an outer surface of the gasket.

Each insert may include an end, adjacent to the outer diameter of the gasket, which is at least partially rounded and fits into a rounded surface on the inner diameter of the bell end. Each insert may be made of steel or hardened steel.

The system may further include gasket retaining bars attached to the body to prevent the gasket from being displaced during insertion of the spigot end of a pipe into the bell end of another pipe. The gasket retaining bars may be molded into the outer diameter of the body and evenly spaced around the circumference of the gasket. The gasket retaining bars and the insert may be placed alternatively around the gasket. The gasket retaining bars may be made of steel or hardened steel. The inserts may be restraining devices or guiding devices.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 is a first embodiment of the invention.

FIG. 2 is a second embodiment of the invention.

FIGS. 3a-c are versions of a third embodiment of the invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

A problem in the art capable of being solved by the embodiments of the present invention is maintaining gasket position during pipe assembly and maintaining pipe assembly during use. It has surprisingly been discovered that inserting retaining bars into a gasket can prevent the gasket from becoming dislodged due to axial forces including those from assembly of the pipes and from internal and external hydrostatic forces. Furthermore, it has surprisingly been discovered that adding restraining inserts to the gasket may prevent the pipes from coming apart during use.

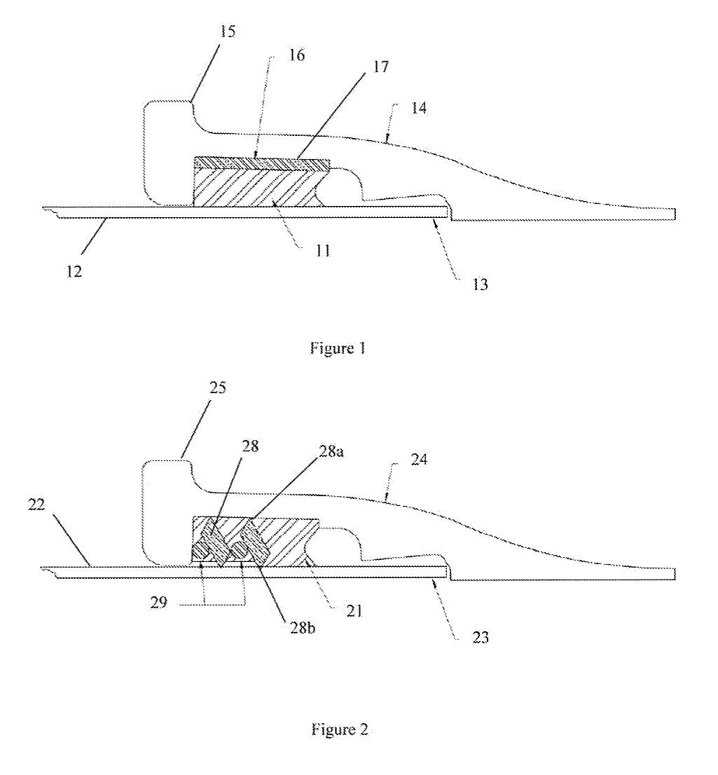

FIG. 1 depicts a first embodiment of a gasket 11. Gasket 11 sits between the spigot end 13 of pipe 12 and the bell end 15 of pipe 14. Gasket 11 may be of any shape; however, gasket 11 is preferably cylindrical in shape, with or without grooves, ribs, or other cylindrical projections to aid in sealing. Gasket 11 may further be of any material including, but not limited to, rubber, silicone, plastic, metal, fiber, etc. Preferably, gasket 11 is of a material that allows a low insertion force to be applied to pipe 12 as it is being inserted into pipe 14. Additionally, there may be grooves in the inner surface of gasket 11 to further reduce the necessary insertion force. However, gasket 11 is preferably resilient enough not to tear if spigot end 13 is un-beveled. Gasket 11 may provide a seal between pipe 12 and pipe 14. The outer diameter of gasket 11 and the inner diameter of bell end 15 may be of complimentary configurations.

Inner diameter of bell end 15 preferably is of a shape to encompass the upper portion of the outer diameter of gasket 11. For instance, in the embodiment shown in FIG. 1, the inner diameter of bell end 15 contains a recess 17 that borders the outer diameter of gasket 11 on three sides, thereby preventing gasket 11 from sliding.

Gasket 11 may be anchored in bell end 15 by mating ribs and grooves on the outer surface of gasket 11 and the inner surface of bell end 15. Furthermore, adhesive may be used to anchor gasket 11 into position. Additionally, the outer diameter of gasket 11 may be slightly larger than the inner diameter of bell end 15 to obtain a compression fit between gasket 11 and bell end 15. Preferably, gasket 11 may have a plurality of gasket retaining bars 16 molded into the outer surface of gasket 11.

Retaining bars 16 may extend the length of gasket 11 in the axial direction. Retaining bars 16 may securely fit into recess 17 to prevent gasket 11 from being displaced during insertion of pipe 12 into pipe 14. Gasket 11 may be flexible to allow insertion into recess 17. Retaining bars 16 may be of any durable, sturdy material capable of withstanding a minimum threshold of physical force. Preferably, retaining bars 16 are comprised of a material stiffer than the gasket material. The number and position of retaining bars 6 can be varied to optimize performance.

FIG. 2 is an embodiment of a gasket 21 having a plurality of inserts 28. Inserts 28 may be of any material capable of withstanding a minimum threshold of physical force. Preferably, inserts 28 are comprised of steel or hardened steel. Exposed ends 28a and 28b of inserts 28 may be hard and impact resistant enough to accept contact with spigot end 23 of pipe 22. However, in certain embodiments, where only alignment is required, inserts 28 may be comprised of plastic or rubber. In such alignment embodiments, the inserts 28 may guide and center the spigot end 23 of pipe 22 into the bell end 25 of pipe 24.

A plurality of inserts 28 are placed in axially spaced rows in gasket 21. Furthermore, a plurality of sets of inserts 28 may be placed circumferentially around gasket 21 at regular intervals. While any number of inserts 28 may be used, preferably at least three inserts 28 are used. Inserts 28 preferably have parallelogram cross-sectional shapes and are aligned such that the surfaces presented to the spigot end 23 of pipe 22 incline away from the throat (outermost opening of the bell end 25 of pipe 24). Furthermore, inserts 28 present an inclined surface to spigot end 23 upon insertion into bell end 25.

Inserts 28 may be restraining devices that prevent pipe 22 from separating from pipe 24 during use of the pipes. In such embodiments, the edges 28a of inserts 28 engage the bell end 25 of pipe 24 and the opposite edges 28b engage the spigot end 23 of pipe 22. In certain embodiments, the inner diameter of bell end 25 may include raised ribs or depressed grooves for edges 28a to engage.

As the spigot end 23 of pipe 22 is inserted through bell end 25 of pipe 24 and gasket 21, the inclination of inserts 28 is increased from the original inclination. This action serves to center spigot end 23 in bell end 25 and align spigot end 23 radially within bell end 25. An extracting action of spigot end 23, whether by external forces such as soil movements or internal pressure, causes edges 28a to engage the inner diameter of bell end 25 and edges 28b to engage the outer diameter of spigot end 23, thus providing axial restraint to the joint in the restraining embodiments.

Over-rotation of inserts 28, in the axial direction, and puncturing of spigot end 23 may be prevented in a variety of ways. Metal blocks 29 may be placed between the inside of bell end 25 and the first insert 28 and in-between inserts 28. The shape of the end of inserts 28 may be such that once inserts 28 have rotated the maximum amount, further rotation is prevented by a flat spot behind edge 28b to prevent further penetration of edge 28b into spigot end 23. Bell end 25 may be shaped such that its internal diameter contains locking elements to prevent further rotation of inserts 28. A sufficient number of inserts 28 may be placed circumferentially around gasket 21 such that the radial force of any one insert 28 is less than the force required to penetrate spigot end 23. Other ways of preventing puncturing spigot end 23 may include, controlling the number, length, and inclination of inserts 28, features incorporated into the ends of inserts 28, features incorporated into the gasket 21, and/or selection of materials. Each of these methods could be used alone or in conjunction with one or more other methods.

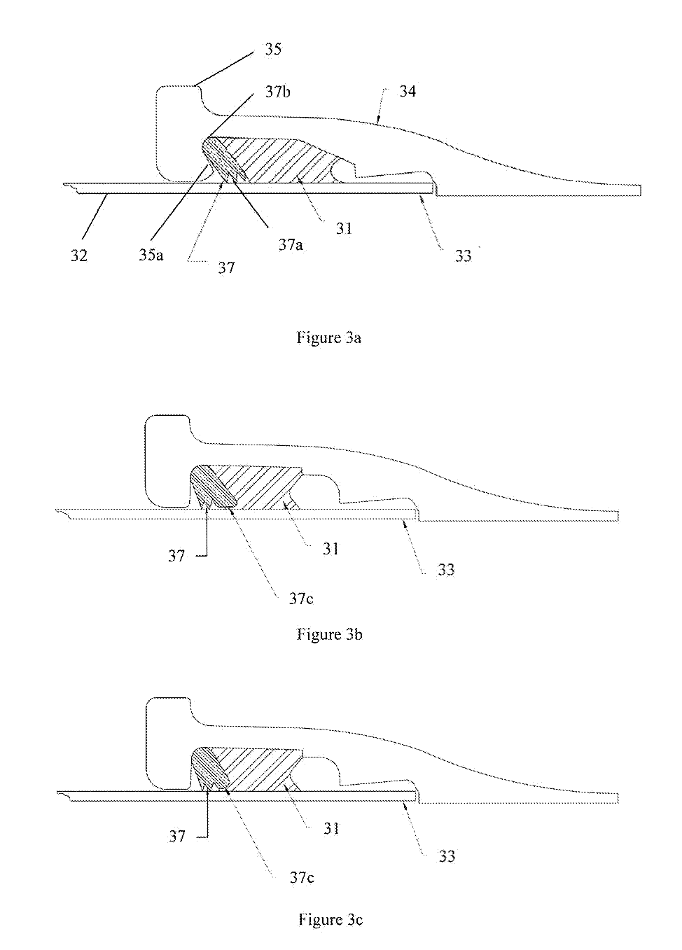

FIGS. 3a-c show another embodiment of a gasket 31 where the insert is a pivoting segment 37. Pivoting segment 37 may be of any material capable of withstanding a minimum threshold of physical force. Preferably, pivoting segment 37 is comprised of steel, hardened steel, or any other material harder than the pipe spigot 33. The teeth 37a of pivoting segment 37 may be hard and impact resistant enough to accept contact with spigot end 33 of pipe 32. In certain embodiments pivoting segment 37 may be used solely for guiding and centering spigot end 33 of pipe 32 into bell end 35 of pipe 34. In such embodiments, pivoting segment 37 may be of any material including, but not limited to, rubber and plastic.

In certain embodiments, pivoting segment 37 may have teeth 37a capable of engaging the spigot end 33 of pipe 32. Pivoting segment 37 may also have a rounded end 37b that fits into and is able to rotate within a complementary rounded section of the inner diameter of bell end 35 of pipe 34. Pivoting segment 37 may have any number of teeth 37a, preferably 2 or more. A plurality of pivoting segments 37 may be regularly spaced circumferentially around gasket 31. Any number of pivoting segments 37 may be used, but preferably at least 3 pivoting segments 37 are used.

Variations in this embodiment include using multiple single-toothed locking elements, which function by booking single-toothed elements side-to-side to function as a multi-toothed unit. Such multiple single-toothed elements can be formed more easily than a single multi-toothed element since there is no internal tooth root to be formed and sharp teeth can be achieved by a simple grinding or machining operation. The multi-toothed embodiment may be formed by any method known, for instance, cold drawing, investment casting, and machining.

Pivoting segment 37 works in a similar manner to inserts 28 of the embodiment shown in FIG. 2. Specifically, in certain restraining embodiments, as spigot end 33 is inserted into bell end 35 through gasket 31, pivoting segment 37 pivots toward the inner diameter of bell end 35. An extracting action of spigot end 33 causes pivoting segment 37 to rotate away from the inner diameter of bell end 35 and causes teeth 37a to engage the outer surface of spigot end 33, thus providing axial restraint to the joint. Over-rotation of pivoting segment 37 may be prevented by the structure of bell end 35, or by other means.

FIGS. 3b and 3c show a pivoting segment 37 having an over-rotation prevention device 37c. An over-rotation prevention device 37c may be any shape, for instance flat (as shown in FIG. 3b), convexly curved, stepped, or rounded (as shown in FIG. 3c). Over-rotation prevention device 37c may be used to prevent over-rotation and puncturing of spigot end 33 of pipe 32. In certain embodiments, over-rotation prevention device 37c may be a stepped-down surface to the back extension of pivoting segment 37 and/or may be covered by the gasket material. In such embodiments, the contact between the end of segment 37 and spigot end 33 would be cushioned, thus aiding in preventing over-rotation.

In certain embodiments, as shown in FIG. 3a, the back 35a of bell end 35 may be inclined from the vertical to provide a stop for pivoting segment 37. Inclined back 35a may help to prevent over-rotation. Alternately, back 35a may be left vertical and pivoting segment 37 may be modified to all it to bottom-out before pivoting segment 37 becomes vertical enough to penetrate spigot end 33.

In certain embodiments, a lubricant coating may be applied to the surface of a gasket. Such a lubricant may facilitate movement of the gasket over the dry pipe spigot without a bevel over the rubber portion of the gasket. Preferably the lubricant is a dry-film lubricant, such as polytetrafluoroethylene, however any lubricant known may be used, including but not limited to vegetable based lubricants, solid aliphatic alcohols, silicone-bonded graphite, waxes, etc.

While the embodiments of FIGS. 1, 2, and 3a-c are shown and described individually, the embodiments may be joined into further embodiments in any manner. Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A gasket comprising:
a body having an o-shape, the body including an inner diameter and an outer diameter; and
at least one gasket retaining bar coupled to the body, wherein the gasket retaining bar prevents the gasket from being displaced while the gasket is under axial force.

2. The gasket of claim 1, wherein the at least one gasket retaining bar is molded into the outer diameter of the body.

3. The gasket of claim 1, wherein there are a plurality of evenly spaced gasket retaining bars.

4. The gasket of claim 1, wherein the at least one gasket retaining bar is comprised of a rigid material.

5. The gasket of claim 1, wherein the: body is made of a flexible material.

6. The gasket of claim 5, wherein the flexible material is rubber.

7. The gasket of claim 1, wherein the gasket is adapted to fit into the inner diameter of a bell end of a pipe.

8. A gasket comprising:
a body having an o-shape, the body including an inner diameter and an outer diameter; and
at least one insert coupled to the body, wherein the insert has at least one edge that extends beyond the inner diameter of the body.

9. The gasket of claim 8, wherein there are a plurality of inserts molded into the body.

10. The gasket of claim 9, wherein each insert has one edge that extends beyond the inner diameter of the body and one edge that extends to the outer diameter of the body.

11. The gasket of claim 9, wherein the inserts are made of steel.

12. The gasket of claim 9, further comprising anti-over-rotation devices to prevent over-rotation of the inserts.

13. The gasket of claim 12, wherein the anti-over-rotation devices are metal blocks placed adjacent to the restraining devices.

14. The gasket of claim 8, wherein the body is made of a flexible material.

15. The gasket of claim 14, wherein the flexible material is rubber.

16. The gasket of claim 8, wherein the gasket is adapted to fit into the inner diameter of a bell end of a pipe.

17. The gasket of claim 8, wherein each insert has a plurality of teeth.

18. The gasket of claim 17, wherein each insert is comprised of a plurality of individual plates placed adjacently and in direct contact to each other, each plate having at least one tooth.

19. The gasket of claim 17, wherein each insert is axially coupled to an outer surface of the gasket.

20. The gasket of claim 19, wherein each insert includes an end, adjacent to the outer diameter of the gasket, which is at least partially rounded.

21. The gasket of claim 17, wherein each insert is made of a material harder than the pipe spigot.

22. The gasket of claim 17, further comprising at least one over-rotation prevention device.

23. The gasket of claim 22, wherein each insert is coupled to an over-rotation prevention device.

24. The gasket of claim 17, wherein the at least one, over-rotation prevention device is one of flat, convexly curved, stepped, and rounded.

25. The gasket of claim 8, further comprising at least one gasket retaining bar coupled to the body, wherein the gasket retaining bar prevents the gasket from being displaced while the gasket is under axial force.

26. The gasket of claim 25, wherein at least one gasket retaining bar is molded into the outer diameter of the body.

27. The gasket of claim 25, wherein there are a plurality of evenly spaced gasket retaining bars.

28. The gasket of claim 27, wherein there are a plurality of inserts and the gasket retaining bars and the inserts are placed alternatively around-the gasket.

29. The gasket of claim 25, wherein the at least one gasket retaining bar is made of steel.

30. The gasket of claim 8, wherein the insert is one of a restraining device and a guide.

31. The gasket of claim 8, further comprising a lubricant coating on a surface of the gasket that contacts the spigot end of the adjoining pipe.

32. A piping system comprising:
at least two pipes, each pipe having a bell end and a spigot end, wherein the spigot end of one pipe fits into the bell end of another pipe; and
at least one gasket, wherein the gasket is adapted to fit into the bell end and provide a seal between the spigot end and the bell end;
each gasket having a body having an o-shape, the body including an inner diameter and an outer diameter; and
at least one gasket retaining bar coupled to the body, wherein the gasket retaining bar prevents the gasket from being displaced during insertion of the spigot end into the bell end.

33. The piping system of claim 32, wherein at least one gasket retaining bar is molded into the outer diameter of the body.

34. The piping system of claim 32, wherein there are a plurality of evenly spaced gasket retaining bars.

35. The piping system of claim 32, wherein the at least one gasket retaining bar is made of a material stiffer than the material of the gasket body.

36. The piping system of claim 32, wherein the body is made of a flexible material.

37. The piping system of claim 36, wherein the flexible material is rubber.

38. A piping system comprising:
at least two pipes, each pipe having a bell end and a spigot end, wherein the spigot end of one pipe fits into the bell end of another pipe; and
at least one gasket, wherein the gasket is adapted to fit into the bell end and provide a seal between the spigot end and the bell end;
each gasket having a body having an o-shape, the body including an inner diameter and an outer diameter; and
at least one insert coupled to the body, wherein the insert has at least one edge that extends beyond the inner diameter of the body and is adapted to engage an outer surface of the spigot end.

39. The piping system of claim 38, wherein there are a plurality of inserts molded into the body.

40. The piping system of claim 38, wherein each insert has one edge that extends beyond the inner diameter of the body to engage an outer surface of the spigot end and one edge that extends beyond the outer diameter of the body to engage an inner surface of the bell end.

41. The piping system of claim 38, wherein the inserts are made of a material harder than the spigot end.

42. The piping system of claim 38, further comprising anti-over-rotation devices to prevent over-rotation of the inserts.

43. The piping system of claim 42, wherein the anti-over-rotation devices are metal blocks placed adjacent to the inserts.

44. The piping system of claim 38, wherein the body is made of a flexible material.

45. The piping system of claim 44, wherein the flexible material is rubber.

46. The piping system of claim 38, wherein each insert has a plurality of teeth.

47. The piping system of claim 46, wherein each insert is comprised of a plurality of individual plates placed adjacently and in direct contact to each other, each plate having at least one tooth.

48. The piping system of claim 46, wherein each insert is axially coupled to an outer surface of the gasket.

49. The piping system of claim 48, wherein each insert includes an end, adjacent to the outer diameter of the gasket, which is at least partially rounded and fits into a rounded surface on the inner diameter of the bell end.

50. The piping system of claim 46, wherein each insert is made of steel.

51. The piping system of claim 38, further comprising at least one gasket retaining bar coupled to the body, wherein the gasket retaining bar prevents the gasket from being displaced during insertion of the spigot end of the first pipe into the bell end of the second pipe.

52. The piping, system of claim 51, wherein the at least one gasket retaining bar is molded into the outer diameter of the body.

53. The piping system of claim 52, wherein there are a plurality of evenly spaced gasket retaining bars.

54. The piping system of claim 53, wherein there are a plurality of inserts and the gasket retaining bars and the inserts are placed alternatively around the gasket.

55. The piping system of claim 51, wherein at least one gasket retaining bar is made of steel.

56. The gasket of claim 38, wherein the insert is one of a restraining device and a guide.

57. The gasket of claim 56, wherein the restraining device prevents axial forces from removing the spigot end from the bell.

58. The gasket of claim 57, wherein the axial forces are due to internal hydrostatic forces.

59. The gasket of claim 58, wherein the axial force is due to an external force.

60. The gasket of claim 59, wherein the external force is soil movement.
